(19) United States
(12) Patent Application Publication
(10) Pub. No.: US 2004/0109045 A1
(43) Pub. Date: Jun. 10, 2004

(54) Print head for micro-deposition of bio-molecules

(75) Inventor: Thomas E. Kocher, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/313,072

(22) Filed: Dec. 6, 2002

(51) Int. Cl. B41J 2/045

(52) U.S. Cl. 347/68

(57) ABSTRACT

A print head for depositing molecular liquids on a substrate comprising: a block of prezoelectic material including at least one void passing through the block and first and second electrodes respectively coating the void and the block, such that application of a voltage between the electrodes produces a radial force to constrict the void and eject liquid contained in the void.

### FIELD OF THE INVENTION

This invention relates in general to molecular biological systems and, more particularly to a means by which micro-array receivers of molecular biological reagents and samples can be produced. More particularly, the invention provides a means by which small volumes of molecular biological liquids can be deposited onto rigid, semi-rigid or flexible supports for the production of micro-array receivers.

### BACKGROUND OF THE INVENTION

As is well known (and described for example in U.S. Pat. No. 5,807,522, inventors Brown et al. and in “DNA Microarrays: A Practical Approach”, Schena, Mark, New York, Oxford University Press, 1999, ISBN 0-19-963776-8), micro-arrays are arrays of very small samples of purified DNA or protein target material arranged as a grid of hundreds or thousands of small spots on a substrate. When the micro-array is exposed to selected probe material, the probe material selectively binds to the target spots only where complementary bonding sites occur, through a process called hybridization. Subsequent quantitative scanning in a fluorescent micro-array scanner may be used to produce a pixel map of fluorescent intensities (See, e.g., U.S. Pat. No. 5,895,915, inventors DeWeerd et al.). This fluorescent intensity map can then be analyzed by special purpose algorithms that reveal the relative concentrations of the fluorescent probes and hence the level of gene expression, protein concentration, etc., present in the cells from which the probe samples were extracted.

Historically, microarrays could be constructed either manually or mechanically through the use of photolithographic, robotically controlled or other apparatus for the precise metering and placement of molecules. Alternatively, microarrays could be constructed through direct chemical synthesis on a solid support. Such devices and methods have the undesirable result that micro-arrays with a great number of individual spots and thus a great number of individual molecular biological reagents are contained with little or no means to identify them uniquely, either by human observations or machine.

Many examples exist for dispensing liquids in small volumes in the range of milliliters to sub-fractions of milliliters. For example, Pastinen et al. (Genome Research, 7-606-614 (1997)) create an array of oligonucleotides by manually applying 0.5˜IL of a solution of 5′-amino-modified oligonucleotides onto an epoxide-activated glass slide to produce a 3×3 array of oligonucleotides on a 0.36 cm˜area of a preprinted glass slide.

Other, more traditional printing methods have been used to create patterns of a few different reagents on a solid support. Means such as silk screening, offset printing, and rotogravure printing have been used in the production of reagent test strips. In such methods, each reagent ink is applied separately. Johnson, for example, (U.S. Pat. No. 4,216,245) discusses methods for the production of reagent test strip devices.

Pipette dispensing of reagents can be automated. Automation potentially increases the speed and accuracy of array production, while decreasing the necessary spacing between array positions. However, the utility of automated pipetting methods are severely limited in the number of different reagents that may be simultaneously applied (low parallelism). Cozzette et al., for example, (U.S. Pat. No. 5,554,339) discusses the use of microsyringes for dispensing reagents during the production of bio-sensor devices.

High-speed robotics have also been used to print micro-arrays of amino-modified cDNA molecules onto silylated glass microscope slides (CEL Associates, Houston) or poly-1-lysine coated microscope slides (Schena, BioEssays, 18:427-431 (1996); Schena et al., Proc. Natl. Acad. Sci., U.S.A., 93:10614-10619 (1996).

Another approach to microarray printing is an adaptation of ink-jetting technology. For example, Hayes et al., U.S. Pat. No. 4,877,745 discusses an ink-jet type method and apparatus for dispensing reagents, particularly in the production of reagent test strips.

Pin transfer is one approach that allows the simultaneous transfer of greater numbers of samples than possible with the above approaches. Examples of such pins are discussed in U.S. Pat. No. 5,770,151, inventors Roach et al. and U.S. Pat. No. 5,807,522, inventors Brown et al.

Pirrung et al., U.S. Pat. No. 5,143,854, Fodor et al., U.S. Pat. No. 5,510, 270, inventors, Fodor et al., U.S. Pat. No. 5,445,934, and Chee et al., International Patent Application, WO 95/11995 discuss the production of high 2 density oligonucleotide arrays through a photolithographic, directly onto a derivatized glass substrate.

McGall et al., U.S. Pat. No. 5,412,087 discusses a method for the production of a high density oligonucleotide array from pre-sythesized oligonucleotides.

Birch et al, U.S. Pat. No. 6,051,190 and U.S. Pat. No. 6,303,387 discusses a transfer rod for distribution of small amounts of liquid in biological or chemical analysis.

Bryning et al, U.S. Pat. No. 6,296,702 B1 discusses an oscillating fiber apparatus for dispensing small volumes of a selected liquid onto a substrate. Similarly, Dannoux et al, International Patent Application WO 00/30754 discusses a method and apparatus for printing high-density biological arrays utilizing a plurality of rods housed with a channel.

Capillary transfer is another approach that allows the simultaneous transfer of greater numbers of samples. Chen et al, US Patent Application Publication No. 2001/0053334 discusses a print system and method of printing probe micro-arrays with capillary bundles. Similarly, Rogers et al., WO 00/01859 discusses a gene pen apparatus for repetitive printing of arrays.

In view of the above, the need is apparent for an efficient means for depositing molecular biological reagents and samples that are contained on solid or semi-solid or flexible supports.

### SUMMARY OF THE INVENTION

According to the present invention, there is provided a solution to the problems discussed above.

According to a feature of the present invention, there is provided a print head for depositing molecular liquids on a substrate comprising:

a block of piezoelectic material including at least one void passing through said block; and

first and second electrodes respectively coating said void and said block, such that application of a voltage between said electrodes produces a radial force to constrict said void and eject liquid contained in said void.

### ADVANTAGEOUS EFFECT OF THE INVENTION

The invention has the following advantages.

1. Improved systems productivity is provided for the production of microarrays of biological and chemical molecules on a rigid, semi-rigid or flexible supports.

2. Means are provided for depositing a large number of unique small volumes of molecular biological and chemical liquids on a substrate.

### BRIEF DESCRIPTION OF THE DRAWINGS

FIG. 1 is a diagrammatic view showing a “Net Shaped” piezoelectric material with cylindrical void.

FIG. 2 is a diagrammatic view showing an electrode configuration for the “Net Shaped” material of FIG. 1.

FIG. 3 is a diagrammatic view showing a simple print head configuration with a glass capillary tube inserted into the void and a fluidic connection.

FIG. 4 is a diagrammatic view showing a print head configuration of FIG. 3 with an orifice plate attached to the glass capillaries.

FIG. 5 is a diagrammatic view showing a print head configuration of a linear array of capillary tubes.

FIG. 6 is a diagrammatic view showing a print head configuration of a matrix of capillary tubes.

FIG. 7 is a diagrammatic view of a print head configuration where the voids created by the “Net shaped” process is the channel for molecular biological liquids.

### DETAILED DESCRIPTION OF THE INVENTION

In general, this invention describes a print head device for micro-deposition of molecular biological or chemical liquids on a solid or semi-solid or flexible support. Approximately 1000 molecular biological liquids need to be uniquely placed on a 2-D grid, each solution occupying approximately 50-500 micro meter (um) diameter spot and preferably 50-200 um spot diameter. This invention is advantaged in that it provides an efficient means by which a large number of small volume molecular biological reagents can be deposited.

Specifically, a print head is proposed where the deposition process is created by a pressure pulse derived from a piezoelectric element. This element is constructed by a process know as “net shaping” as discussed in Chatterjee et al., U.S. Pat. Nos. 6,065,195 and 6,168,746. This process provides the advantage of producing complex 3-D (three-dimensional) mechanical shapes with reduced manufacturing steps. As discussed in U.S. Pat. No. 6,168,746, this process consists of the steps: spray drying fine particulate ceramic ferroelectric material to form agglomerate material; mixing the spray dried fine particulate ceramic ferroelectric agglomerate material with a binder system including materials selected from the group consisting of wax having wax components of different molecular weight, magnesium-X silicate, agaroid gel forming material, and agaroid gel forming material mixed with magnesium-X silicate to form a compounded material; injecting the compounded material at a selected pressure into a mold to form a green article; debinding or drying the green article; sintering the debinded or dried green article to form the final molded article; poling the final molded article to align the electrical dipoles within the piezoelectric material; and forming a coating of conductive material over the top and bottom surfaces of the final molded article.

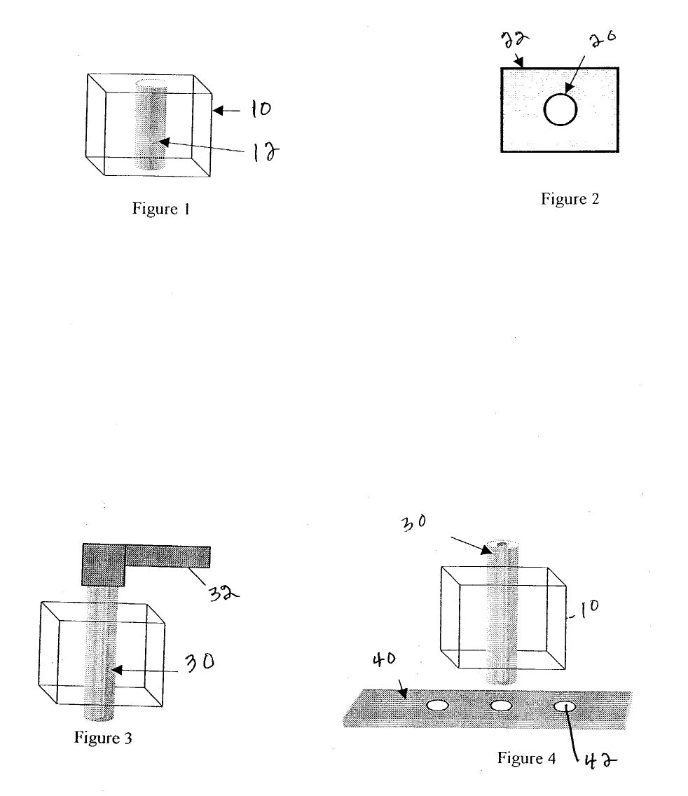

In one embodiment of this invention as shown in FIG. 1, a block 10 of ferroelectric material, preferably a piezoelectric material and preferably lead zirconate titinate (PbZrTiO₃) is formed to create a geometry with cylindrical voids 12. A first electrode 20 (FIG. 2) covers void 12 and a second electrode 22 covers block 10. The poling process is done such that when a voltage is applied between electrodes 20,22, a radial force is created at the cylindrical void 12. As shown in FIG. 3, each void contains a glass or plastic capillary 30 that is held in place with suitable cement. Examples of glass capillaries suitable for this application are available from Nippon Electric Glass, Inc. Capillary inside diameters on the order of 30-100 um and preferably in the range of 30-60 um are appropriate. The aforementioned radial force acts on the tube, which contains the molecular biological liquids, ejecting a drop of known volume. The molecular biological or chemical liquids are connected to the glass capillaries via suitable flexible or rigid tubing 32. A variant of this embodiment is shown in FIG. 4 includes an orifice plate 40 having orifices 42 that would cover the ends of the glass capillary(s).

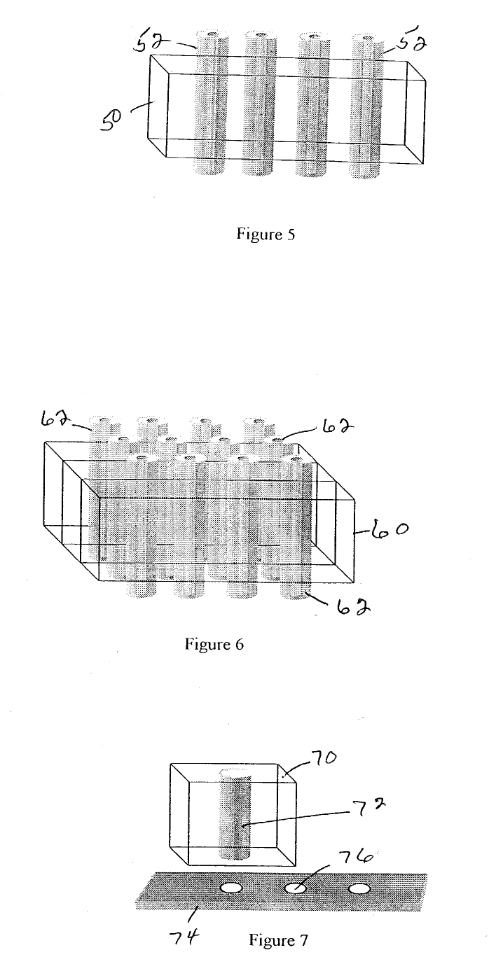

In yet another variant of this embodiment shown in FIG. 5, the piezoelectric element contains a linear array of 1×N capillary elements 52.

Yet another embodiment shown in FIG. 6, the piezoelectric element 60 contains an M×N array of capillary elements 62.

In another embodiment of this invention shown in FIG. 7, a block of ferroelectric material 70, preferably a piezoelectric material and preferably lead zirconate titinate (PbZrTiO₃) is formed to create a molded geometry with cylindrical voids 72 where each void is the channel for containing molecular biological and chemical liquids. An orifice plate 74 with apertures 76 covers the end of the molded channels. The shape of the voids could be geometries other than circular such as square or rectangular.

An electric signal is applied to the electrodes (See FIG. 2) to produce the necessary force to produce the ejection of a drop of liquid.

The invention has been described in detail with particular reference to certain preferred embodiments thereof, but it will be understood that variations and modifications can be effected within the spirit and scope of the invention.

### Parts List

10 block of ferroelectric material

12 cylindrical void

20,22 electrodes

30 glass or plastic capillary

32 rigid tubing

40 orifice plate

42 orifice

50 piezelectric element

52 capillary elements

60 piezelectric element

62 capillary elements

70 ferroelectric material

72 cylindrical voids

74 orifice plate

76 apertures

What is claimed is:

1. A print head for depositing molecular liquids on a substrate comprising:
a block of piezoelectic material including at least one void passing through said block; and
first and second electrodes respectively coating said void and said block, such that application of a voltage between said electrodes produces a radial force to constrict said void and eject liquid contained in said void.

2. The print head of claim 1 wherein said at least one void contains a glass or plastic capillary tube for containing a molecular liquid to be ejected.

3. The print head of claim 1 including a plate on said block having an orifice aligned with said at least one void.

4. The print head of claim 1 including a tube connected to said orifice for supplying molecular liquid to said at least one void in said block.

5. The print head of claim 1 wherein said block is made of lead zirconate titonate material.

6. The print head of claim 1 wherein said block includes a linear array spaced of voids passing through said block.

7. The print head of claim 1 wherein said block includes an array of spaced voids passing through said block.
